(19) United States
(12) Patent Application Publication
(10) Pub. No.: US 2024/0236760 A1
(43) Pub. Date: Jul. 11, 2024

(54) A METHOD AND APPARATUS FOR BUFFER STATUS REPORT WITH INTEGRATED ACCESS BACKHAUL IN A WIRELESS COMMUNICATION SYSTEM

(71) Applicant: SAMSUNG ELECTRONICS CO., LTD., Suwon-si, Gyeonggi-do (KR)

(72) Inventors: Milos TESANOVIC, Staines, Middlesex (GB); Jaehyuk JANG, Suwon-si (KR); Sangkyu BAEK, Suwon-si (KR)

(21) Appl. No.: 18/559,551

(22) PCT Filed: May 9, 2022
(86) PCT No.: PCT/KR2022/006530

§ 371 Date: Nov. 7, 2023

(30) Foreign Application Priority Data
May 10, 2021 (GB) 2106656.8

(51) Int. Cl. H04W 28/02

(52) U.S. Cl. CPC H04W 28/0278

(57) ABSTRACT

The disclosure relates to a 5G or 6G communication system for supporting a higher data transmission rate. There are disclosed methods for providing a Buffer Status Report (BSR), the methods comprising: creating the BSR; and transmitting the BSR. In a first method, the BSR comprises one octet including an LCG ID field of length 3 bits and a Buffer Size field of length 5 bits, and the Buffer Size field indicates a total amount of data available for transmission associated with an LCG identified based on a combination of the LCG ID field and an LCID or eLCID associated with the BSR.

### TECHNICAL FIELD

Certain examples of the present disclosure provide various techniques relating to buffer status report (BSR), in particular in a network incorporating integrated access and backhaul (IAB), for example within 3rd generation partnership project (3GPP) 5th generation (5G) new radio (NR) and NR-based relay networks.

### BACKGROUND ART

5G mobile communication technologies define broad frequency bands such that high transmission rates and new services are possible, and can be implemented not only in “Sub 6 GHZ” bands such as 3.5 GHZ, but also in “Above 6 GHZ” bands referred to as mmWave including 28 GHZ and 39 GHz. In addition, it has been considered to implement 6G mobile communication technologies (referred to as Beyond 5G systems) in terahertz bands (for example, 95 GHZ to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the present disclosure. No determination has been made, and no assertion is made, as to whether any of the above might be applicable as prior art with regard to the present invention.

### DISCLOSURE OF INVENTION

### Technical Problem

In 3rd Generation Partnership Project (3GPP) 5th Generation (5G) New Radio (NR), Integrated Access and Backhaul (IAB) is a technique for providing wireless backhaul as an alternative to a fibre backhaul network. An IAB network comprises IAB nodes, at which wireless resources are shared between wireless backhaul and access links. Due to the limited coverage area of an IAB node, the backhaul network is typically implemented as a multi-hop network with backhaul traffic traversing multiple IAB nodes.

The IAB is based on NR whose scheduling mechanisms include Buffer Status Report (BSR). A UE transmits a BSR to a network node (gNB) to report the amount of data in the UE Uplink (UL) buffer available for transmission. A BSR may be triggered in a number of different circumstances, and may have a variety of different formats.

3GPP 5G Release 16 has been frozen and work on Release 17 is currently underway. An aim of Release 17 is to develop and improve features relating to IAB relative to the Release 16 baseline. These include achieving greater topology-wide fairness, developing BSR formats and triggers, and ensuring node interoperability.

### Solution to Problem

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

The present invention is defined in the independent claims. Advantageous features are defined in the dependent claims.

Embodiments or examples disclosed in the description and/or figures falling outside the scope of the claims are to be understood as examples useful for understanding the present invention.

### Advantageous Effects of Invention

Other aspects, advantages, and salient features of the invention will become apparent to those skilled in the art from the following detailed description taken in conjunction with the accompanying drawings.

### BRIEF DESCRIPTION OF DRAWINGS

For a more complete understanding of this disclosure and its advantages, reference is now made to the following description, taken in conjunction with the accompanying drawings, in which:

FIG. 1 illustrates one example architecture for multi-hop backhauling (source TR 38.874);

FIG. 2 illustrates an example IAB network topology;

FIGS. 3a and 3b illustrate first and second BSR formats;

FIGS. 4a to 4e illustrate further BSR formats according to various examples of the present disclosure; and

FIG. 5 is a block diagram of an exemplary network entity that may be used in examples of the present disclosure.

### MODE FOR THE INVENTION

The following description of examples of the present disclosure, with reference to the accompanying drawings, is provided to assist in a comprehensive understanding of the present invention, as defined by the claims. The description includes various specific details to assist in that understanding but these are to be regarded as merely exemplary. Accordingly, those of ordinary skill in the art will recognize that various changes and modifications of the examples described herein can be made.

The same or similar components may be designated by the same or similar reference numerals, although they may be illustrated in different drawings.

Detailed descriptions of techniques, structures, constructions, functions or processes known in the art may be omitted for clarity and conciseness, and to avoid obscuring the subject matter of the present disclosure.

The terms and words used herein are not limited to the bibliographical or standard meanings, but, are merely used to enable a clear and consistent understanding of the examples disclosed herein.

Throughout the description and claims, the words “comprise”, “contain” and “include”, and variations thereof, for example “comprising”, “containing” and “including”, means “including but not limited to”, and is not intended to (and does not) exclude other features, elements, components, integers, steps, processes, functions, characteristics, and the like.

Throughout the description and claims, the singular form, for example “a”, “an” and “the”, encompasses the plural unless the context otherwise requires. For example, reference to “an object” includes reference to one or more of such objects.

Throughout the description and claims, language in the general form of “X for Y” (where Y is some action, process, function, activity or step and X is some means for carrying out that action, process, function, activity or step) encompasses means X adapted, configured or arranged specifically, but not necessarily exclusively, to do Y.

Features, elements, components, integers, steps, processes, functions, characteristics, and the like, described in conjunction with a particular aspect, embodiment, example or claim are to be understood to be applicable to any other aspect, embodiment, example or claim disclosed herein unless incompatible therewith.

The following examples are applicable to, and use terminology associated with, 3GPP 5G. However, the skilled person will appreciate that the techniques disclosed herein are not limited to these examples or to 3GPP 5G, and may be applied in any suitable system or standard, for example one or more existing and/or future generation wireless communication systems or standards. The skilled person will appreciate that the techniques disclosed herein may be applied in any existing or future releases of 3GPP 5G NR or any other relevant standard.

For example, the functionality of the various network entities and other features disclosed herein may be applied to corresponding or equivalent entities or features in other communication systems or standards. Corresponding or equivalent entities or features may be regarded as entities or features that perform the same or similar role, function, operation or purpose within the network. For example, the functionality of an IAB node in the examples below may be applied to any other suitable type of entity performing functions of a network node.

The skilled person will appreciate that certain examples of the present disclosure may not be directly related to standardization but rather proprietary implementation of some of the Integrated Access and Backhaul (IAB) functions or non-IAB related functions of NR Rel-17 and beyond networks.

The skilled person will appreciate that the present invention is not limited to the specific examples disclosed herein. For example:
The techniques disclosed herein are not limited to 3GPP 5G.
The techniques disclosed herein are not limited to IAB or relay networks.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements, entities and/or messages may be added to the examples disclosed herein.
One or more non-essential elements, entities and/or messages may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed may be modified, if possible, in alternative examples.
The transmission of information between network entities is not limited to the specific form, type and/or order of messages described in relation to the examples disclosed herein.

Certain examples of the present disclosure may be provided in the form of an apparatus/device/network entity configured to perform one or more defined network functions and/or a method therefor. Such an apparatus/device/network entity may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). Certain examples of the present disclosure may be provided in the form of a system (e.g. a network) comprising one or more such apparatuses/devices/network entities, and/or a method therefor. For example, in the following examples, a network may include one or more IAB nodes.

It will be appreciated that examples of the present disclosure may be realized in the form of hardware, software or a combination of hardware and software. Certain examples of the present disclosure may provide a computer program comprising instructions or code which, when executed, implement a method, system and/or apparatus in accordance with any aspect, claim, example and/or embodiment disclosed herein. Certain embodiments of the present disclosure provide a machine-readable storage storing such a program.

To satisfy extremely high data rate requirements, the 3GPP 5G NR standard utilises communication frequencies in a relatively high range, from 30 GHz to 300 GHz, corresponding to wavelengths in the millimetre (mm) range (mmWave communication). Such mmWave communication provides a large available bandwidth and high transmission speeds. However, problems with mmWave communication include severe signal path loss and low penetration, resulting in a relatively short transmission range. This in turn requires a greater density of base stations deployment.

Due to the relatively high cost and other difficulties associated with deployment of fibre transport network links, wireless backhauling can be used as an alternative. Integrated Access and Backhaul (IAB), in which a part of the radio resources is used for backhauling, is standardized in 3GPP Rel-16.

According to 3GPP TR 38.874, the backhaul architecture supports multi-hop backhauling in which backhaul traffic is wirelessly relayed by network nodes via one or more hops with some hops using mmWave communication in certain deployments. Multi-hop backhauling provides more range extension than single hop. This is es-pecially beneficial for above-6 GHz frequencies due to their limited range. Multi-hop backhauling further enables backhauling around obstacles, e.g. buildings in urban en-vironment for in-clutter deployments.

Also according to TR 38.874, IAB reuses existing functions and interfaces defined for access. In particular, Mobile-Termination (MT), gNB-DU, gNB-CU, UPF, AMF and SMF as well as the corresponding interfaces NR Uu (between MT and gNB), F1, NG, X2 and N4 are used as baseline for the IAB architectures.

The Mobile-Termination (MT) function has been defined as a component of the Mobile Equipment, and is referred to as a function residing on an IAB-node that terminates the radio interface layers of the backhaul Uu interface toward the IAB-donor or other IAB-nodes.

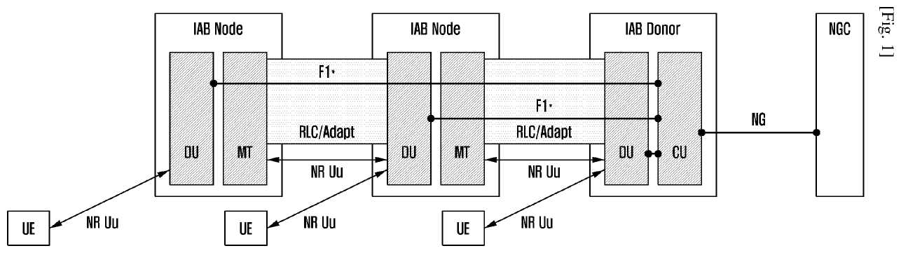

FIG. 1 illustrates one example architecture for multi-hop backhauling defined in TR 38.874, showing the reference diagram for a two-hop chain of IAB-nodes un-derneath an IAB-donor, where IAB-node and UE connect in SA-mode to an NGC.

An IAB-node may be defined as a RAN node that supports wireless access to UEs and wirelessly backhauls the access traffic. An IAB-donor may be defined as a RAN node which provides UE's interface to core network and wireless backhauling functionality to IAB-nodes.

The architecture of FIG. 1 leverages CU/DU-split architecture. That is, the IAB donor node comprises a Central Unit (CU) and one or more Distributed Units (DUs), with an interface called F1 between them. The functionality of the IAB donor is divided between the CU (hosting Radio Resource Control (RRC), Service Data Adaption Protocol (SDAP) and Packet Data Conversion Protocol (PDCP), and which terminates the F1 interface connected with the DU) and DU (hosting Radio Link Control (RLC), Medium Access Control (MAC) and Physical (PHY) layers, and which terminates the F1 interface with the CU) logical nodes. The internal structure (CU/DU) of the IAB donor is not visible to other nodes and the 5G core network (5GC). See 3GPP TS 38.401.

In the architecture of FIG. 1, each IAB-node holds a DU and an MT. Via the MT, the IAB-node connects to an upstream IAB-node or the IAB-donor. Via the DU, the IAB-node establishes RLC-channels to UEs and to MTs of downstream IAB-nodes. For MTs, this RLC-channel may refer to a modified RLC*. An IAB-node can connect to more than one upstream IAB-node or IAB-donor DU. The IAB-node may contain multiple DUs, but each DU part of the IAB-node has F1-C connection only with one IAB-donor CU-CP.

The donor also holds a DU to support UEs and MTs of downstream IAB-nodes. The IAB-donor holds a CU for the DUs of all IAB-nodes and for its own DU. It is assumed that the DUs on an IAB-node are served by only one IAB-donor. This IAB-donor may change through topology adaptation. Each DU on an IAB-node connects to the CU in the IAB-donor using a modified form of F1, which is referred to as F1*. F1*-U runs over RLC channels on the wireless backhaul between the MT on the serving IAB-node and the DU on the donor. An adaptation layer is added—named Backhaul Adaptation Layer (BAP)—which performs bearer mapping and routing. It replaces the IP functionality of the standard F1-stack. F1*-U may carry a GTP-U header for the end-to-end association between CU and DU.

The Uu interface represents the interface between the UE and the DU in an IAB node. The F1* interface represents the interface between the IAB DU and an upstream CU.

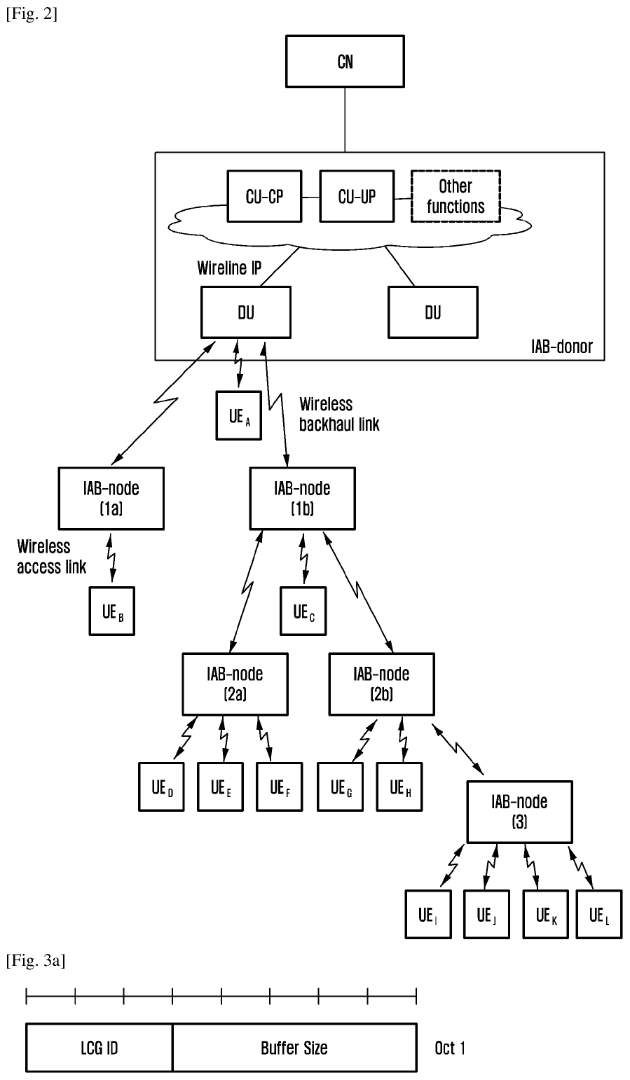

FIG. 2 illustrates an example IAB network topology. Improvements to topology-wide fairness is one of the objectives of the Rel-17 IAB work. While working on Rel-16, the assumption was that fairness would be enabled by implementation and ensured by operators. In Rel-17, there is a desire to provide normative mechanisms to ensure and improve fairness across the topology. 3GPP is currently in the early stages of discussing this topic, with the focus being on identifying issues with Rel-16 baseline.

The Technical Report on IAB (TR 38.874 v16.0.0, published in December 2018 and capturing the outcome of the Study Item phase) discusses fairness in IAB networks by stating the following (which is not binding in any normative way):

“An IAB network should attempt to schedule the wireless resources to meet each UE bearer's requirement regardless of the number of hops a given UE is away from the Donor DU.”

The following observation is then made with regards to an important difference between 1:1 and N:1 bearer mapping across the backhaul:

“When one-to-one mapping is used between UE bearer and RLC-channel on the backhaul, the IAB-node has explicit information on each UE bearer and can therefore apply appropriate QOS differentiation among QoS profiles, as well as fairness among UE bearers with same QoS profile.

While QOS differentiation is still possible when UE bearers are aggregated to backhaul RLC-channels, enforcement of fairness across UE bearers becomes less granular.”

In NR and LTE networks, in order to assist scheduling done by the base station/access point, the terminal (UE) provides feedback on the occupancy of its buffers. This mechanism is known as Buffer Status Reporting, or BSR. BSR can be trigger-based or configured to be sent periodically and uses several different formats (3GPP TS 38.321). For purposes of BSR, radio bearers/logical channels are grouped into LCH groups, or LCGs. In NR Rel-16, the number of LCGs is limited to 8.

At the most recent RAN2 meeting (RAN2 #113bis-e, April 2021) the following was agreed:

“LCG range to be extended for IAB-MT. Size of LCG and enhancements to BSR are FFS”

This agreement—which essentially introduces finer reporting of buffer status—may be viewed as (among other things) a way to assist in alleviating the above-mentioned issue with fairness in IAB networks, because:
It can ensure better QoS management—e.g. if bearers are mapped onto BH channels in a 1:1 manner, but then if there is a need to group them for purposes of buffer status reporting into ‘just’ 8 groups (as per Rel-16 NR baseline)—then this cancels out some of the benefits of the 1:1 mapping.
It can help prevent congestion on the uplink by identifying a specific LCH or a small group of LCHs where a buffer is close to a threshold, and then schedule/bring forward for scheduling just those LCHs.
It can ensure per-bearer or per-UE scheduling.

Certain examples of the present disclosure provide changes to the baseline Rel-16 NR BSR mechanism, including triggers, formats and node interoperability.

The skilled person will appreciate that the various techniques disclosed herein, including disclosed in the description, figures and claims, may be applied to any suitable type of BSR. For example, the techniques (e.g. formats and/or triggers) disclosed herein may be applied to “normal” BSR (e.g. BSR exchanged on the NR Uu interface between a UE and a network node, as well as on the NR Uu interface between two IAB nodes), but may also be applied to pre-emptive BSR and Sidelink BSR (e.g. see 3GPP TS 38.321). References in the present disclosure to BSR include references to any suitable type of BSR to which the techniques may be applied, including the types mentioned above.

Certain examples of the present disclosure provide a method for providing a Buffer Status Report (BSR), the method comprising: assembling (or creating) the BSR, wherein the BSR comprises one octet including an LCG ID field of length 3 bits and a Buffer Size field of length 5 bits, and wherein the Buffer Size field indicates a total amount of data available for transmission associated with an LCG identified based on a combination of the LCG ID field and an LCID or cLCID associated with the BSR.

In certain examples: if the LCID or eLCID has a first predetermined value (e.g. 61 or 59), the LCG ID field may identify the LCG as an LCG among a first set of LCGs (e.g. LCG₀-LCG₇); and if the LCID or eLCID has a second predetermined value (e.g. 43 or 44), the LCG ID field may identify the LCG as an LCG among a second set of LCGs (e.g. LCG₈-LCG₁₅).

Certain examples of the present disclosure provide a method for providing a Buffer Status Report (BSR), the method comprising: assembling (or creating) the BSR, wherein the BSR comprises two octets including an LCG ID field of length 4 or more bits and a Buffer Size field (e.g. of length 12 or fewer bits), and wherein the Buffer Size field indicates a total amount of data available for transmission associated with an LCG identified based on the LCG ID field.

In certain examples, the LCG ID field may have a length 8 bits and the Buffer Size field may have a length 8 bits.

In certain examples, if an amount of space for padding is less than the size of the BSR, the BSR may instead comprise one octet including an LCG ID field of length 3 bits and a Buffer Size field of length 5 bits.

Certain examples of the present disclosure provide a method for providing a Buffer Status Report (BSR), the method comprising: assembling (or creating) the BSR, wherein the BSR comprises: an LCG field comprising two octets for indicating whether or not each LCG within a set of 16 LCGs has data available for transmission; and zero or more Buffer Size fields, each Buffer Size field comprising one octet and indicating a total amount of data available for transmission associated with a respective LCG indicated in the LCG field as having data available for transmission.

Certain examples of the present disclosure provide a method for providing a Buffer Status Report (BSR), the method comprising: assembling (or creating) the BSR, wherein the BSR comprises: an LCG field comprising one octet for indicating whether or not each LCG within a set of 8 LCGs has data available for transmission; and zero or more Buffer Size fields, each Buffer Size field comprising one octet and indicating a total amount of data available for transmission associated with a respective LCG indicated in the LCG field as having data available for transmission, and wherein the set of 8 LCGs is determined based on an ID (e.g. LCID or eLCID) associated with the BSR.

In certain examples: if the LCID or eLCID has a first predetermined value, the set of 8 LCGs may comprise a first set of LCGs (e.g. LCG₀-LCG₇); and if the LCID or eLCID has a second predetermined value, the set of 8 LCGs may comprise a second set of LCGs (e.g. LCG₈-LCG₁₅).

In certain examples, the method may further comprise transmitting the BSR.

In certain examples, the method may further comprise transmitting a BSR corresponding to a LCH or LCG if a triggering condition is satisfied, wherein the triggering condition may be based on one or more of: the amount of data available for transmission associated with the LCH or LCG exceeding a threshold, a priority of the LCH or LCG is within a certain range, a source and/or destination of data corresponding to the LCH or LCG.

Certain examples of the present disclosure provide a first network entity (e.g. UE) configured to operate according to a method according to any example, embodiment, aspect and/or claim disclosed herein.

Certain examples of the present disclosure provide a second network entity (e.g. AMF entity) configured to cooperate with a first network entity of the preceding example according to any example, embodiment, aspect and/or claim disclosed herein.

) Certain examples of the present disclosure provide a network (or wireless communication system) comprising a UE and one or more further network entities according to any example, embodiment, aspect and/or claim disclosed herein.

Certain examples of the present disclosure provide a computer program comprising instructions which, when the program is executed by a computer or processor, cause the computer or processor to carry out a method according to any example, embodiment, aspect and/or claim disclosed herein.

Certain examples of the present disclosure provide a computer or processor-readable data carrier having stored thereon a computer program according to the preceding examples.

In certain examples, BSR formats are provided for reporting the BSR with an increased number of LCGs. Various examples are disclosed in the following, including examples that reuse existing BSR formats.

In certain examples disclosed below it is assumed that the number of LCGs is increased to 16. However, the skilled person will appreciate that the present disclosure are not limited to this example and that any other suitable number of LCGs may be used.

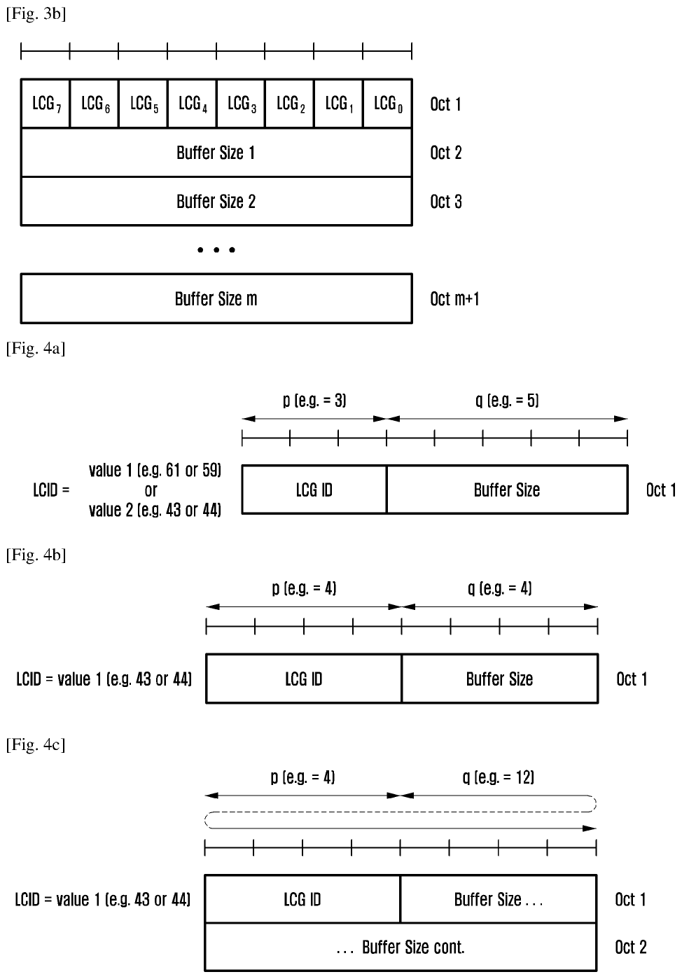

FIGS. 3a and 3b illustrate exemplary BSR formats. In particular, FIG. 3a illustrates the Short BSR format and FIG. 3b illustrates the Long BSR format used in NR Rel-16 (3GPP TS 38.321 v16.4.0).

In FIG. 3a, the LCG ID field identifies the Logical Channel Group whose buffer status is being reported. As illustrated in FIG. 3a, the length of the LCG ID field is 3 bits, allowing for 8 different LCGs. The Buffer Size field (or Buffer Status field) contains a value representing the total amount of data available across all logical channels of a LCG. In particular, the Buffer Size field contains a value which is used as an index to a lookup table that maps different index values to different ranges of data size. As illustrated in FIG. 3a, the length of the Buffer Size field is 5 bits, allowing for 32 different data size ranges. The LCG ID and Buffer Size fields together occupy one octet (Oct 1).

In FIG. 3b, a first octet (Oct 1) comprises eight 1-bit fields (LCG₀, . . . , LCG₇) corresponding to respective different LCGs. Each LCG; field is set to a value (0 or 1) indicating whether the corresponding LCG has data available (1) or does not have data available (0). As illustrated in FIG. 3b, there are 8 LCG; fields allowing for 8 LCGs. The following m octets (Oct 2, . . . , Oct m+1) are Buffer Size fields indicating the total amount of data available for respective LCGs indicated as having data available. The Buffer Size fields are included in ascending order based on the LCGi.

A BSR is typically encapsulated as a Medium Access Control (MAC) Control Element (CE). The BSR formats are identified by MAC subheaders with predefined LCID values, while a Pre-emptive BSR format is identified by a MAC subheader with a predefined eLCID (see 3GPP TS 38.321 V16.4.0 for example). There is one LCID field per MAC subheader. The LCID field size is 6 bits. If the LCID field is set to 34 or 33, one or two additional octet(s) is/are present in the MAC subheader containing the cLCID field. The LCID field of the MAC subheader identifies the type of the corresponding MAC CE. For example, for UL-SCH, LCID values of 59, 60, 61 and 62 indicate “Short Truncated BSR”, “Long Truncated BSR”, “Short BSR” and “Long BSR”, respectively, while values 35-44 are reserved. For UL-SCH, the value of two-octet eLCID identifies the logical channel. For UL-SCH, a one-octet eLCID value (codepoint) of 255 indicates “Pre-emptive BSR”, while values (codepoint) 0-249 are reserved.

In certain examples of the present disclosure, the number of LCGs may be increased, for example to 16 or any other suitable number. The following examples define both “short” and “long” formats (corresponding to FIGS. 3a and 3b, respectively) suitable for 16 LCGs but the skilled person will appreciate that these formats may be adapted for other numbers of LCGs and may be referred to by any suitable name. The following exemplary BSR formats may be referred to as Rel-17 BSR, although the skilled person would appreciate that these techniques are not limited to Rel-17.

The following three examples relate to a short/short truncated format.

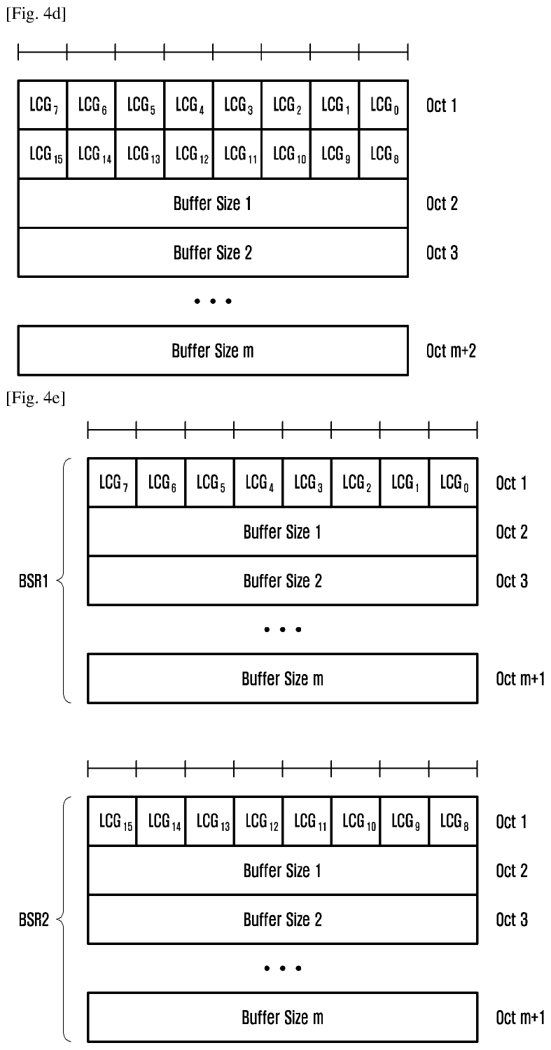

In a first example, illustrated in FIG. 4a and based on the structure of FIG. 3a, the BSR format comprises an LCG ID field with a length of p bits and a Buffer Size field with a length of q bits. Similar to the format of FIG. 3a, the LCG ID field contains a value identifying an LCG from among a set of up to 2º LCGs, and the Buffer Size field contains a value indicating the total amount of data available across all logical channels of the LCG identified in the LCG ID field. As with the format of FIG. 3a, the Buffer Size field value may be an index to a lookup table (or may represent the amount of data in any other suitable way, for example as a value indicating the amount of data directly).

The values of p and q may be chosen to sum to 8 so that the overall body size of the BSR format of FIG. 4a occupies one octet, like the format of FIG. 3a. In certain examples, values of p=3 and q=5 may be used so that the individual fields of the format of FIG. 4a are the same sizes as the corresponding fields of the format of FIG. 3a. In order to extend the number of LCGs reportable using the format of FIG. 4a, for example relative to the format of FIG. 3a, the following technique may be used.

The LCG ID value identifies one LCG from among a predefined set of LCGs, where each possible p-bit LCG ID value is mapped to a corresponding LCG in a predefined set of 2^{p} LCGs. A value (e.g. LCID or any other suitable identifier) associated with the BSR may be used to indicate the particular set of LCGs from which the LCG identified by the LCG ID value is selected. Accordingly, different values (e.g. different LCIDs) may be used to indicate different predefined sets of LCGs. For example, when the LCID associated with the BSR has a first predetermined value (e.g. 61 or 59) then the LCG ID value indicates an LCG from among a first set of LCGs (e.g. LCG₀, LCG₁, . . . , LCG₇), and when the LCID associated with the BSR has a second predetermined value (e.g. a reserved value, for example 43 or 44) then the LCG ID value indicates an LCG from among a second set of LCGs (e.g. LCG₈, LCG₉, . . . , LCG₁₅). The skilled person will appreciate that the number of LCGs may be extended further by using more than two values (e.g. LCID) to indicate more that two sets of LCGs. The skilled person will also appreciate that, in any of the examples disclosed herein involving LCID, suitable LCID may be chosen from the LCID and/or eLCID space (e.g. reserved values).

By defining the format of FIG. 4a to have the same overall body size and individual field sizes as the legacy short BSR (FIG. 3a), the impact on the standard is reduced. However, since additional LCID values are required, the available LCID space is reduced.

In a second example illustrated in FIG. 4b, similar to the first example, the BSR format comprises an LCG ID field of length p bits and a Buffer Size field of length q bits. However, in the example of FIG. 4b the value of p may be increased to allow for a greater number of (i.e. up to 2P) LCGs. For example, a value of p=4 as illustrated in FIG. 4b allows for 16 LCGs. The values of p and q may sum to 8 as illustrated in FIG. 4b so that the overall body size of the BSR format occupies a single octet. Increasing the value of p while maintaining an overall fixed body size of the BSR format requires the value of q to be reduced by a corresponding amount, thereby reducing the number of buffer size levels (i.e. resulting in coarser granularity). However, this allows the number of LCGs to be increased without requiring use of an additional LCID. Also, by defining the format of FIG. 4b to have the same overall body size as the legacy short BSR format (FIG. 3a), the impact on the standard is reduced.

In a third example illustrated in FIG. 4c, similar to the first example, the BSR format comprises an LCG ID field of length p bits and a Buffer Size field of length q bits. However, in the third example the overall body size of the BSR format may be increased by increasing the values of p and/or q. For example, p and q may be chosen to sum to 16 as illustrated in FIG. 4c so that the overall body size of the BSR format occupies 2 octets. For example, a value of p=4 or p=6 may be chosen to allow for up to 16 or 32 LCGs, leaving between 12 and 10 bits for the Buffer Size field. This provides a BSR format allowing for a relatively greater number of LCGs while also allowing relatively finer granularity of buffer size levels. For example, a short BSR format may be provided allowing finer granularity than the legacy long BSR format (e.g. FIG. 3b). If a value of q=8 is chosen then the granularity of the legacy long BSR format (e.g. FIG. 3b) may be used.

In some situations, a BSR may be sent as padding. However, if the overall size of the BSR format (e.g. the overall size of a MAC CE encapsulating the BSR, including header) is larger than an amount of space available for padding, then it may not be possible to send the BSR in that particular format. This problem may occur more frequently if the size of the BSR is increased in order to extend the number of LCGs, for example using certain techniques described above. For example, when two octets are used, then in some rare cases (e.g. where there is very little room for padding), the Short BSR cannot be sent when it would normally be sent as padding.

However, in certain examples, it may be possible to switch between different BSR formats (e.g. between the example of FIG. 3a and the formats of the three preceding examples) when necessary. For example, a Rel-17 IAB-MT may switch between an enhanced (Rel-17) BSR (e.g. the three preceding examples) and a regular Short BSR (e.g. FIG. 3a) if the above problem arises.

The following two examples relate to a long/long truncated format.

In a first example, illustrated in FIG. 4d and based on the structure of FIG. 3b, a first part of length u bits contains u 1-bit LCG fields allowing the presence of u LCGs to be indicated, and a second part contains m sub-parts, each of length v bits, and each containing a Buffer Size field. For example, the value of v may be chosen as 8 so that each Buffer Size field occupies a single octet, similar to the format of FIG. 3b. The value of u may be chosen to increase the number of LCGs compared to the format of FIG. 3b. For example, the value of u may be chosen to be 16 so that the first part occupies 2 octets allowing for 16 LCGs. The first octet may identify the presence of the first eight LCGs, LCG₀-LCG₇, and the second octet may identify the presence of the next eight LCGs, LCG₈-LCG₁₅. In this case, the format is similar to the format of FIG. 3b except that a second octet is added to identify the presence of eight further LCGs, i.e. LCG₈-LCG₁₅. In view of the addition of a further octet, either an unused LCID or an ELCID may be used to identify the presence of LCG₈-LCG₁₅.

In a second example illustrated in FIG. 4c, the number of LCGs indicated may be increased by using multiple long BSR. For example, a first long BSR (e.g. according to FIG. 3b or the first example above) may be used for a first set of LCGs (e.g. 8 LCGs) and a second long BSR (e.g. according to FIG. 3b or the first example above) may be used for a second set of LCGs (e.g. the next 8 LCGs). The different BSRs may be dis-tinguished by using different LCIDs. This may result in higher overhead.

In certain examples of the present disclosure, including any of the above examples, the skilled person will appreciate that at least a part of the BSR format (e.g. one or more bits) may be reserved for other use(s). For example, if the overall body size of the BSR format is Sₒᵥₑᵣₐₗₗ bits, S_{LCG_ID} bits are used for the LCG ID field and S_{buffer_size} bits are used for the Buffer Size field, then S_{reserved} bits may be reserved for other use(s), where Sₒᵥₑᵣₐₗₗ=S_{LCG_ID}+S_{buffer_size}+S_{reserved}.

Herein, references to the overall body size of the BSR format may refer to the combined size of the various fields, for example LCG ID field+Buffer Size fields of FIGS. 3a and 4a-c or LCG fields+Buffer Size fields of FIGS. 3b and 4d-c. Where the BSR format includes a part reserved for other uses, such a part may be regarded as contributing part of the overall body size of the BSR format. Where a BSR is encapsulated as a MAC CE including a header (containing LCID), references to the overall body size of the BSR format may exclude the header part. In this case, the overall size including the header part and body part may be referred to as the overall size of the BSR format.

In certain examples of the present disclosure, one or more triggering conditions for determining when to trigger a BSR, may be defined. Various examples are disclosed below, which may be used individually or in any suitable combination. A BSR may be transmitted if one or more triggering conditions are satisfied and there is an UL grant. Satisfying the triggering condition(s) may lead to assembly of a BSR (BSR MAC CE) according to an appropriate BSR format, for example as described herein. Transmission of the BSR may then be carried out in a subsequent step if there is UL grant for the transmission, and if this grant meets certain requirements (e.g. as described in the padding case above). Accordingly, in some circumstances, transmission of a BSR may not actually take place (e.g. if a triggering condition is not satisfied, if there is no UL grant, or if an UL grant does not meet certain requirements).

In a first example, specific LCH/LCGs may be allowed to trigger the BSR. For example, such triggering may be based on a threshold (e.g. the amount of data available for transmission with respect to a specific LCH/LCG exceeds a threshold). A BSR may be triggered regardless of priority of the data/LCH/LCG. In some examples, a BSR may only be triggered if the priority of the data/LCH/LCG falls within a certain priority range. Triggering may not be limited to top-priority data/LCH/LCG. In the present disclosure, the priority of a LCG may be defined in any suitable manner, for example as the highest priority among LCHs within the LCG, or as the priority of a designated LCH within the LCG.

In a second example, specific LCH/LCGs may be allowed to trigger a BSR based on the data source and/or destination (for example, in IAB networks, this may mean the origin/destination UE, IAB node, or IAB Donor DU).

One specific scenario where the second example may be beneficial is when data with the highest priority for a single UE arrives, but this data does not have the highest priority overall (across all LCHs of an IAB-MT), for example:
An IAB node has available data with priorities p=1 and p=3 from UE1.
This IAB node receives a data with p=2 from UE2. Based on the current BSR triggering, a regular BSR would not be triggered (the presence of this data will be reported in the next periodic/regular BSR).
If the IAB parent node wishes to allocate the radio resource with granularity of UE (or group of UEs), e.g. in order to ensure fairness, it would be desirable to send a BSR in this case and certain examples of the present disclosure allow this.

Certain examples of the present disclosure address interoperability issues when nodes with different capabilities or configurations (e.g. Rel-16 and Rel-17 nodes) are adjacent (e.g. have a parent/child relationship) to each other. For example, one problem is that a node of a first type (e.g. a Rel-16 node) may not understand a BSR (e.g. Rel-17 BSR) configured or formatted for a node of a second type (e.g. a Rel-17 node).

In certain examples, the above problem may be avoided by appropriate configuration. For example, an IAB-donor may consider the topology and supported features and only configure a BSR of a certain configuration/format (e.g. a Rel-17 BSR) when this will be understood by/useful to an adjacent node.

In certain examples, in a situation where a node does not understand a BSR, the node may drop the BSR. For example, since the (e) LCID may be unrecognizable to the receiving node, the Rel-16 node may just drop the BSR from Rel-17 node.

In certain examples, the network may configure Rel-17 nodes to only report Rel-16 compliant BSRs.

Certain examples of the present disclosure may provide a capability to allow a node to indicate support for a BSR of certain format, for example one or more of the formats disclosed above (e.g. a Rel-17 BSR). The feature may be configured to a child node based on its capability (for example similar to other features). In some cases, for example in networks including mobile nodes, or in the case of link failures leading to topology changes, the compatibility of neighbouring nodes may change. It is therefore beneficial for a node to be able to signal support for BSR of a certain format (e.g. Rel-17 BSR).

The following, with reference to FIG. 2, illustrates a specific example of some of the techniques described above.

This example considers IAB-node 2b from FIG. 2, and assumes that there is 1:1 mapping across the entire network between UE radio bearers (i.e. each UE has only one bearer in this example) and backhaul channels. The skilled person would appreciate that similar teaching may be applied to the other nodes in FIG. 2.

The following mapping (Table 1) shows some examples of input to output LCH mapping (upstream direction) and LCG grouping:

TABLE 1

| | Mapping to | Mapping to | | |
|---|---|---|---|---|
| | egress channels | egress channels | Example LCG | Example LCG |
| | of IAB-node 3 | of IAB-node 2b | grouping no. 1 | grouping no. 2 |
| UEi | LCH_3_1 | LCH_2b_1 | LCG_1 | LCG_1 |
| UEj | LCH_3_2 | LCH_2b_2 | LCG_1 | LCG_2 |
| UEk | LCH_3_3 | LCH_2b_3 | LCG_1 | LCG_3 |
| UEl | LCH_3_4 | LCH_2b_4 | LCG_2 | LCG_4 |
| | UEg | LCH_2b_5 | LCG_2 | LCG_5 |
| | UEh | LCH_2b_6 | LCG_2 | LCG_6 |

In the example grouping number 1, it is assumed that there is a limit of 2 LCGs. It is further assumed that UE; and UE have higher QoS requirements and are mapped to higher-priority channels at IAB-node 2b (LCH_2_b_1 and LCH_2_b_2).

Under the Rel-16 baseline, assuming there is existing data in LCG₁ and LCG₂ buffers, arrival of data from UE_{g} (and mapped into LCG₂) would not trigger a BSR towards node 1b. This may not be a problem per se, since it is assumes that this data is of lower priority overall.

However, there may be circumstances in which a BSR not being triggered may be a potential problem. For example, such circumstances may include (i) if it is desired to increase or ensure fairness (e.g. in cases where lower priority overall could still mean highest priority for an individual UE), (ii) if it is desired to allocate resources with per-UE granularity, or even groups of UEs, and/or (iii) if data from all UEs are of similar QOS requirements.

Certain examples of the present disclosure address this problem by allocating a separate LCG for each of the UEs, as in example grouping no. 2. As noted above, in this example there is only one bearer per UE, but in alternative examples there may be multiple bearers per UE each mapped to individual backhaul channel.

Assuming now there are multiple bearers per UE, certain examples of the present disclosure may configure grouping based on relative and not overall priority. For example grouping no. 2 in Table 1 is one relatively simple example of this. For example, the bearers from individual UEs with highest individual priority (per UE) may be grouped together into LCG_1, and then bearers from individual UEs with second highest individual priority (per UE) into LCG_2, etc. This will ensure triggering of the BSR when data arrives for the highest-priority bearer of a given UE, which does not have highest priority overall.

Accordingly, certain examples of the present disclosure may allow triggering of BSR based on source (e.g. a UE from which data originates; a group of UEs; or a specific child or descendent IAB-node). As in the example above, this may be done based on 1:1 mapping between UE bearers and backhaul channels. One example is given in Table 1. In a variation of this example, an N:1 mapping may be assumed, whereby bearers of a UE are mapped onto a single backhaul channel, or bearers from multiple UEs attaching to the same node, or subsets of bearers from different UEs but with similar QoS requirements. This aggregation may mitigate issues with a limit imposed on the number of LCGs. In some cases, such a limit may prohibit per-UE/per-bearer BSR reporting (even when extended according to the techniques described above).

Certain examples of the present disclosure may ensure that—in the case where new data arrives in a LCG (which gathers bearers from a single UE/source) and there is already data in a LCG with higher priority—a BSR will nevertheless be triggered.

When 1:1 mapping is used, and also N:1 mapping (whereby all bearers from a single UE are aggregated onto a single backhaul channel), the network may infer the source UE/node based on a given backhaul channel.

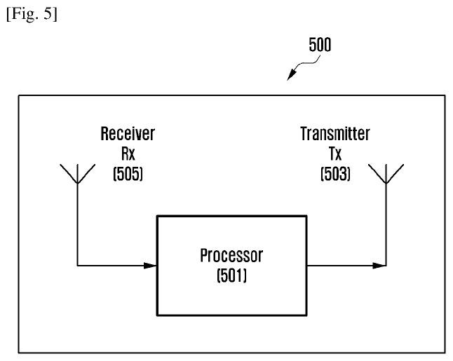

FIG. 5 is a block diagram of an exemplary network entity (e.g. IAB Node or IAB Donor) that may be used in examples of the present disclosure. The skilled person will appreciate that the network entity illustrated in FIG. 5 may be implemented, for example, as a network element on a dedicated hardware, as a software instance running on a dedicated hardware, or as a virtualised function instantiated on an appropriate platform, e.g. on a cloud infrastructure.

The entity 500 comprises a processor (or controller) 501, a transmitter 503 and a receiver 505. The receiver 505 is configured for receiving one or more messages from one or more other network entities. The transmitter 503 is configured for transmitting one or more messages to one or more other network entities. The processor 501 is configured for performing operations as described above.

While the invention has been shown and described with reference to certain examples, it will be understood by those skilled in the art that various changes in form and detail may be made therein without departing from the scope of the invention, as defined by the appended claims.

Certain examples of the present disclosure provide one or more techniques as disclosed in the following annex to the description. The skilled person will appreciate that any of these techniques may be applied in combination with any of the techniques described above and illustrated in the Figures.

In the present disclosure, the following abbreviations and definitions may be used.

3GPP 3rd Generation Partnership Project

5G 5th Generation

5GC 5G Core

AMF Access and Mobility Management Function

BAP Backhaul Adaptation Layer

BH Backhaul

BSR Buffer Status Report

CE Control Element

CP Control Plane

CU Central Unit

DU Distributed Unit

eLCID extended LCID

F1 interface between DU and CU

F1-C F1 Control information

F1*-U Modified F1-U (carried over wireless backhaul in IAB)

FFS For Further Study

gNB 5G base station

GPRS General Packet Radio Service

GTP-U GPRS Tunnelling Protocol

IAB Integrated Access and Backhaul

ID Identity/Identification

IP Internet Protocol

LCG Logical Channel Group

LCH Logical Channel

LCID Logical Channel ID

LTE Long Term Evolution

MAC Medium Access Control

MT Mobile Termination

N4 Interface between Control Plane and User Plane

NG Interface between 5G RAN and Core

NGC Control part of NG

NR New Radio

Oct Octet

PDCP Packet Data Conversion Protocol

PHY Physical

QOS Quality of Service

RAN Radio Access Network

RAN2 Radio layer 2 and Radio layer 3 Working Group

Rel Release

RLC Radio Link Control

RRC Radio Resource Control

SA mode Stand-Alone mode

SCH Shared Channel

SDAP Service Data Adaption Protocol

SMF Session Management Function

TR Technical Report

TS Technical Specification

UE User Equipment

UL UpLink

UP User Plane

UPF User Plane Function

Uu Air interface between terminal and base station/access point

X2 interface between 2 base stations

Although this disclosure has been described with an exemplary embodiment, various changes and modifications may be suggested to one skilled in the art. It is intended that this disclosure encompass such changes and modifications as fall within the scope of the appended claims.

### INDUSTRIAL APPLICABILITY

The present disclosure may be used to report a buffer status in a wireless communication system using an Integrated Access and Backhaul scheme.

1.-13. (canceled)

14. A method performed by a network entity in a wireless communication system, the method comprising:
generating a buffer status report (BSR); and
transmitting, to a base station, the BSR,
wherein the BSR comprises two octets including a logical channel group (LCG) identifier (ID) field and a buffer size field,
wherein the buffer size field indicates a total amount of data available for transmission associated with an LCG identified based on the LGC ID field.

15. The method of claim 14, wherein the LCG ID field has length of 8 bits and the Buffer Size field has length of 8 bits.

16. A method performed by a network entity in a wireless communication system, the method comprising:
generating a buffer status report (BSR); and
transmitting, to a base station, the BSR,
wherein the BSR comprises:
an LCG field comprising two octets for indicating whether or not each LCG within a set of 16 LCGs has data available for transmission; and
buffer size fields, each Buffer Size field comprising one octet and indicating a total amount of data available for transmission associated with a respective LCG indicated in the LCG field.

17. The method of claim 16, wherein an extended logical channel ID (eLCID) is used for the LCG field.

18. The method of claim 16,
wherein the network entity is an integrated access and backhaul (IAB) node, and
wherein a format of the BSR is supported by the IAB node.

19. A network entity in a wireless communication system, the network entity comprising:
a transceiver; and
a processor operably coupled with the transceiver and configured to:
generate a buffer status report (BSR), and
transmit, to a base station, the BSR,
wherein the BSR comprises two octets including a logical channel group (LCG) identifier (ID) field and a buffer size field,
wherein the buffer size field indicates a total amount of data available for transmission associated with an LCG identified based on the LGC ID field.

20. The network entity of claim 19, wherein the LCG ID field has length of 8 bits and the Buffer Size field has length of 8 bits.

21. A network entity in a wireless communication system, the network entity comprising:
a transceiver;
a processor operably coupled with the transceiver and configured to:
generate a buffer status report (BSR), and
transmit, to a base station, the BSR,
wherein the BSR comprises:
an LCG field comprising two octets for indicating whether or not each LCG within a set of 16 LCGs has data available for transmission; and
buffer size fields, each Buffer Size field comprising one octet and indicating a total amount of data available for transmission associated with a respective LCG indicated in the LCG field.

22. The network entity of claim 21, wherein an extended logical channel ID (eLCID) is used for the LCG field.

23. The network entity of claim 21,
wherein the network entity is an integrated access and backhaul (LAB) node, and
wherein a format of the BSR is supported by the IAB node.
